(19) United States
(12) Patent Application Publication
(10) Pub. No.: US 2024/0365442 A1
(43) Pub. Date: Oct. 31, 2024

(54) Flexible Heat Preservation Board

(71) Applicant: Guangdong Willing Technology Corporation, Huizhou (CN)

(72) Inventors: Jingnong Ye, Huizhou (CN); Shifa Luo, Huizhou (CN); Kunhuan Feng, Huizhou (CN)

(21) Appl. No.: 18/646,924

(22) Filed: Apr. 26, 2024

(30) Foreign Application Priority Data
Apr. 27, 2023 (CN) 202321013145.6

(51) Int. Cl. H05B 3/36

(52) U.S. Cl. CPC H05B 3/36; H05B 2203/003; H05B 2203/014; H05B 2203/016

(57) ABSTRACT

The present disclosure relates to the technical field of heat preservation boards and, particularly to a flexible heat preservation board, including a heating pad and a heating wire, in which the heating pad is formed with a limiting groove for threading the heating wire, the limiting groove is uniformly distributed around the heating pad, the heating pad is provided with a power supplier to which an end of the heating wire is connected, a side of the heating pad is formed with a plurality of protruding structures having a same height, and the heating pad and the heating wire are both made of flexible materials. The proposed disclosure solves the problem that most of the existing meal heating devices are made of metal or glass materials, which, due to their high rigidity, lead to occupying a large space when they are not required for use and are difficult to store.

### CROSS REFERENCE TO RELATED APPLICATIONS

The present application claims the benefit of Chinese Patent Application No. 202321013145.6 filed on Apr. 27, 2023, the contents of which are incorporated herein by reference in their entirety.

### FIELD

The present disclosure relates to the technical field of heat preservation boards and, particularly, to a flexible heat preservation board.

### BACKGROUND

With the increasing improvement of the living standard of human, people are not only focusing on the nutrition, flavor and characteristics of food, but also paying more attention to maintaining the freshness of the cuisine from the beginning to the end of the meal. Currently, existing tables provide convenience for diners to obtain food, but they do not allow a constant temperature to be kept for warm dishes, thereby affecting the tastes of the dishes. Moreover, after many workers work overtime, they would like to have warm meals when they get home, but they still have to heat the meals for a second time, which affects taste of the meals. Therefore, a meal heating device was developed and invented, i.e., a meal heating device is placed on a tabletop to heat the meal or keep the meal at a constant temperature without heating the meal a second time.

Existing common meal heating devices are mostly made of metal or glass materials (for example, Chinese Patent No. 202222214675.9), which take up a large amount of space and are difficult to store when not in use.

Therefore, a flexible heat preservation board takes advantage of such an opportunity to be invented.

### SUMMARY

Proposed in the present disclosure is a flexible heat preservation board, which solves the problem that most of the existing meal heating devices are made of metal or glass materials, which, due to their high rigidity, lead to a large occupation of space when they are not required for use and are difficult to be stored.

Proposed in the present disclosure is a flexible heat preservation board, including a heating pad and a heating wire, in which the heating pad is formed with a limiting groove for threading the heating wire, the limiting groove is uniformly distributed around the heating pad, the heating pad is provided with a power supplier to which an end of the heating wire is connected, a side of the heating pad is formed with a plurality of protruding structures having a same height, and the heating pad and the heating wire are both made of flexible materials.

Preferably, the flexible heat preservation board further includes a liquid adhesive for encapsulating the heating wire in the limiting groove.

Preferably, an inner side of the limiting groove is provided with a clamping structure, the clamping structure comprises two clamps disposed in opposite directions, and a distance between the clamps and the limiting groove is greater than or equal to a diameter of the heating wire.

Preferably, the clamp is of a bar-shaped structure and is provided in a length direction of the limiting groove.

Preferably, a beginning segment and an end segment of the limiting groove, provided in parallel to each other, are extended toward an outer edge of the flexible heat preservation board, then bent in a U-shape repeatedly toward a centerline of the heating pad, and finally connected.

Preferably, the power supplier is provided on an end of the heating pad, and both ends of the heating wire are connected to the power supplier.

Preferably, an end of the power supplier proximal to an edge of the heating pad is provided with a terminal.

Preferably, the protruding structure is distributed on a backside of the heating pad.

Preferably, a front side of the heating pad is overlaid with a thermochromic layer.

It is evident from the above that the following beneficial effects may be achieved by applying the technical solution provided by the present disclosure:

Firstly, in the proposed technical solution of the present disclosure, the heating pad and the heating wire are both made of flexible materials, i.e., the heat preservation board may be stored by rolling up, and the heating wire is sealed in the limiting groove by adhesive, so that the normal work of the heat preservation board may be guaranteed by repeated rolling up and releasing, which greatly improves the storage convenience and ensures the service life of the product.

Secondly, in the proposed technical solution of the present disclosure, the clamping structure in the limiting groove effectively ensures the fixation of the heating wire in the limiting groove and ensures the position of the heating wire is fixed during normal use and during the process of rolling up and storage, thereby ensuring the normal use of the product.

Thirdly, in the proposed technical solution of the present disclosure, the limiting groove is provided in such a way as to effectively ensure that the heating wire is uniformly distributed over an area of the heating pad, thereby rendering the heating effect uniform at various places on the heating pad, which greatly increases the heat preservation area on the heat preservation board, and improves the utilization rate of the heat preservation board.

Fourthly, in the proposed technical solution of the present disclosure, a surface of the heat preservation board is also provided with a thermochromic layer, which is used to warn the current surface temperature of the heat preservation board, which avoids burns caused by accidental touching and improves the safety of the heat preservation board.

### BRIEF DESCRIPTION OF THE DRAWINGS

In order to illustrate the technical solutions of the embodiments of the present disclosure or of the prior art more clearly, the following drawings are briefly described as required in the context of the embodiments or the prior art. Obviously, the following drawings illustrate only some of the embodiments of the present disclosure. Other relevant drawings may be obtained on the basis of these drawings without any creative effort by those skilled in the art.

FIG. 1 is an exploded view of the flexible heat preservation board of the embodiment of the present disclosure;

FIG. 2 is a section view of the flexible heat preservation board of the embodiment of the present disclosure.

### DETAILED DESCRIPTION OF THE EMBODIMENTS

The technical solutions in the embodiments of the present disclosure are clearly and completely described and discussed below in conjunction with the attached drawings of the embodiments of the present disclosure. Obviously, the embodiments described herein are only some of the embodiments of the present disclosure but not all of them. Based on the embodiments in the present disclosure, all other embodiments obtained by those skilled in the art without creative efforts fall within the scope of protection of the present disclosure.

Most of the existing meal heating devices are made of metal or glass materials, which, due to their high rigidity, lead to a large occupation of space when they are not required for use and are difficult to store.

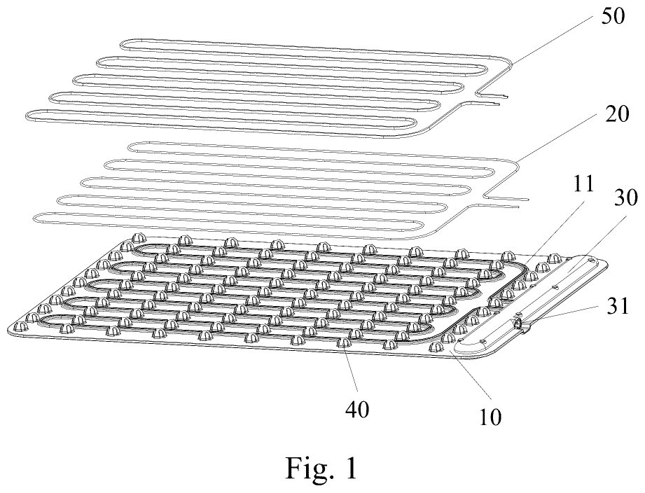

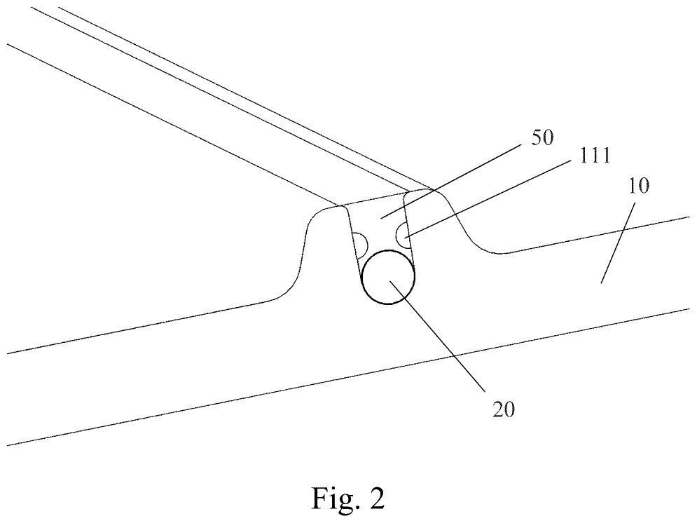

As shown in FIG. 1 and FIG. 2, to solve the aforementioned problems, proposed in the present embodiment is a flexible heat preservation board, including a heating pad 10 and a heating wire 20, in which the heating pad 10 is formed with a limiting groove 11 for threading the heating wire 20, the limiting groove 11 is uniformly distributed around the heating pad 10, the heating pad 10 is provided with a power supplier 30 to which an end of the heating wire 20 is connected, a side of the heating pad 10 is formed with a plurality of protruding structures 40 having a same height, and the heating pad 10 and the heating wire 20 are both made of flexible materials.

Preferably, in the present embodiment, an opening of the limiting groove 11 and the protruding structure 40 are positioned on a same side of the heating pad 10.

Preferably, in the present embodiment, the heating wire 20 is made of flexible materials such as silicone, carbon fiber, graphene, PVC, and PTFE.

Preferably, in the present embodiment, the power supplier 30 is provided convexly and in a same direction as the protruding direction of the protruding structure 40, and an opposite side of the heating pad 10 is of a planar structure.

In the present embodiment, after the heating pad 10 is assembled with the heating wire 20, the overall temperature of the heating pad 10 rises as the heating wire 20 is powered on for increasing time, and the heat is then transferred to the dishes thereon through heat transfer, which achieves a heat preservation effect. Also, as the heating wire 20 in the present embodiment is extended uniformly around the heating pad 10, the temperature is relatively uniform at various places on the heating pad 10, which increases the heat preservation area on the heating pad 10, i.e., the heating pad 10 of the present embodiment may be used for heat preservation of a relatively large number of dishes.

Specifically, the flexible heat preservation board further includes a liquid adhesive 50 for encapsulating the heating wire 20 in the limiting groove 11.

Preferably, in the present embodiment, liquid silicone is selected to encapsulate the heating wire 20.

In the present embodiment, the limiting groove 11 is formed with an opening for the heating wire 20 to be entered into, so that the heating wire 20 is more likely to be detached from the opening under an external force. Therefore, encapsulation by means of the liquid adhesive 50 ensures that the heating wire 20 is still fixed in the limiting groove 11 under the presence of an external force, i.e., it ensures the structural stability of the heat preservation board.

More specifically, an inner side of the limiting groove 11 is provided with a clamping structure, the clamping structure includes two clamps 111 disposed in opposite directions, and a distance between the clamps 111 and the limiting groove 11 is greater than or equal to a diameter of the heating wire 20.

Preferably, in the present embodiment, the clamp is of a bar-shaped structure and is provided in a length direction of the limiting groove 11. It is preferred, but not limited, that the clamps in the present embodiment may also be provided in the form of a block structure and evenly distributed within the limiting groove 11.

Preferably, a cross-section of the clamps 111 is of semicircular shape and their arcuate protrusions are disposed opposite to each other.

Preferably, in the present embodiment, a distance between the clamps 111 is less than a diameter of the heating wire 20. However, as the heating wire 20 and the heating pad 10 are made of flexible materials, the clamps 111 tend to expand outwardly when extruded by the heating wire 20, thereby allowing the heating wire 20 to pass through smoothly. The clamps 111 returns to its original state due to the absence of the external force, achieving an effective fixation effect on the heating wire 20.

In the present embodiment, the clamps 111 achieve a first fixation effect on the heating wire 20, and then the liquid adhesive 50 fills gaps in the limiting groove 11 to achieve a second fixation effect on the heating wire 20, which greatly ensures the fixation state of the heating wire 20.

More specifically, a beginning segment and an end segment of the limiting groove 11, provided in parallel to each other, are extended toward an outer edge of the flexible heat preservation board, then bent in a U-shape repeatedly toward a centerline of the heating pad 10, and finally connected.

Preferably, in the present embodiment, the beginning segment and the end segment of the limiting groove 11 are positioned at the same shorter edge of the heating pad 10 and each is extended in a direction along the longer edge. The limiting groove 11 is then bent in a U-shape repeatedly and extended further in a direction along the longer edge until it is connected to the beginning or end segment.

In the present embodiment, the limiting groove 11 provided by adopting the aforementioned solution effectively ensures that it is uniformly provided along the heating pad 10, thereby ensuring that the heat from the heating wire 20 achieves the overall heating effect of the heating pad 10.

More specifically, the power supplier 30 is provided on an end of the heating pad 10, and both ends of the heating wire 20 are connected to the power supplier 30.

More specifically, an end of the power supplier 30 proximal to an edge of the heating pad 10 is provided with a terminal 31.

Preferably, in the present embodiment, the terminal 31 is used to connect to an external power supply and to power the heating wire 20.

More specifically, the protruding structure 40 is distributed on a backside of the heating pad 10, and a front side of the heating pad 10 is overlaid with a thermochromic layer.

Preferably, in the present embodiment, the thermochromic layer includes a pattern and a color of the pattern changes as the temperature is increased. It is preferred, but not limited, that the closer the color is to red indicates a higher temperature.

Preferably, in the present embodiment, an end of the protruding structure 40 is hemispherical, which may effectively ensure the support effect of the protruding structure 40 on the heating pad 10, and also accelerate the circulation rate of the air under the heating pad 10.

In summary, proposed in the present embodiment is a flexible heat preservation board, which consists of a heating pad and a heating wire made of flexible material, achieves the heat preservation effect of the heating pad after being powered on, and may also be stored by rolling up, and also maintains the normal use of the heating pad under repeated and continuous rolling up and releasing.

The embodiments described above do not constitute a limitation of the scope of protection of the technical solution. Any modifications, equivalent substitutions, improvements, or the like made within the spirit and principles of the above embodiments shall be included in the scope of protection of the technical solution.

1. A flexible heat preservation board, comprising a heating pad and a heating wire, wherein the heating pad is formed with a limiting groove for threading the heating wire, the limiting groove is uniformly distributed around the heating pad, the heating pad is provided with a power supplier to which an end of the heating wire is connected, a side of the heating pad is formed with a plurality of protruding structures having a same height, and the heating pad and the heating wire are both made of flexible materials.

2. The flexible heat preservation board according to claim 1, further comprising a liquid adhesive for encapsulating the heating wire in the limiting groove.

3. The flexible heat preservation board according to claim 2, wherein an inner side of the limiting groove is provided with a clamping structure, the clamping structure comprises two clamps disposed in opposite directions, and a distance between the clamps and the limiting groove is greater than or equal to a diameter of the heating wire.

4. The flexible heat preservation board according to claim 3, wherein the clamp is of a bar-shaped structure and is provided in a length direction of the limiting groove.

5. The flexible heat preservation board according to claim 2, wherein a beginning segment and an end segment of the limiting groove, provided in parallel to each other, are extended toward an outer edge of the flexible heat preservation board, then bent in a U-shape repeatedly toward a centerline of the heating pad, and finally connected.

6. The flexible heat preservation board according to claim 1, wherein the power supplier is provided on an end of the heating pad, and both ends of the heating wire are connected to the power supplier.

7. The flexible heat preservation board according to claim 6, wherein an end of the power supplier proximal to an edge of the heating pad is provided with a terminal.

8. The flexible heat preservation board according to claim 1, wherein the protruding structure is distributed on a backside of the heating pad.

9. The flexible heat preservation board according to claim 1, wherein a front side of the heating pad is overlaid with a thermochromic layer.

10. The flexible heat preservation board according to claim 2, wherein a front side of the heating pad is overlaid with a thermochromic layer.

11. The flexible heat preservation board according to claim 3, wherein a front side of the heating pad is overlaid with a thermochromic layer.

12. The flexible heat preservation board according to claim 4, wherein a front side of the heating pad is overlaid with a thermochromic layer.

13. The flexible heat preservation board according to claim 5, wherein a front side of the heating pad is overlaid with a thermochromic layer.

14. The flexible heat preservation board according to claim 6, wherein a front side of the heating pad is overlaid with a thermochromic layer.

15. The flexible heat preservation board according to claim 7, wherein a front side of the heating pad is overlaid with a thermochromic layer.

16. The flexible heat preservation board according to claim 8, wherein a front side of the heating pad is overlaid with a thermochromic layer.
